(19) United States
(12) Patent Application Publication
(10) Pub. No.: US 2009/0282620 A1
(43) Pub. Date: Nov. 19, 2009

(54) Hand-tool attachment for making relief cuts in lay-down materials

(76) Inventor: Gordon Elliott Leask, Manistee, MI (US)

Correspondence Address: Gordon Elliott Leask, 928 Heather RD, Manistee, MI, 49660, US

(21) Appl. No.: 12/152,005

(22) Filed: May 13, 2008

(51) Int. Cl. B26B 27/00; B26B 3/08

(52) U.S. Cl. 7/158; 30/172

(57) ABSTRACT

A simple, durable, safe and effective hand-tool attachment is provided for making relief cuts in lay-down materials such as asphalt shingles, carpet, linoleum, and tile. The hand-tool attachment has an attachment-box with two thumb set-screws and a free-floating clamping-plate for securing various pre-existing, flat-shaped hand-tools such as roofing shovels, potato forks and floor scrapers; and, attached thereto is an angled knife-blade, supported by a skid plate, extending from the attachment-box. The relief cuts create smaller, workable portions of the lay-down material for easier removal and clean-up using common techniques. The hand-tool attachment may be made of any material that may provides the strength and cutting ability for attaching to a hand-tool and making relief cuts.

### CROSS REFERENCE TO RELATED APPLICATIONS

Provisional Application No. 60/928,504.

Filing Date: May 10, 2007.

### STATEMENT REGARDING FEDERALLY SPONSORED RESEARCH FOR DEVELOPMENT

Not Applicable.

### REFERENCE TO A MICROFICHE APPENDIX

Not Applicable.

### BACKGROUND OF THE INVENTION

In the construction industry tools for roofing and flooring demolitions have not changed much over many years. For example, it is common for asphalt shingles, which are interlocking, to be removed in large sections. This process is slow, laborious and carries much liability.

Therefore, it was desirable to invent a simple, durable, safe and effective tool that attaches to various pre-existing, flat-shaped hand-tools such as roofing shovels, potato forks, floor scrapers, edging tools, etc., for aiding or facilitating the removal of lay-down materials such as asphalt shingles, carpet, flooring tile, or linoleum.

It was also desirable that the invention easily make relief cuts in the lay-down material for the purpose of creating smaller, workable portions of the lay-down material for easy removal and clean-up using common techniques. It was also desirable that the invention be constructed from a material that provides the strength for: (a) attaching to said hand-tools, and (b) making relief cuts, easily slicing through the lay-down material. It was found that high carbon steel is a highly effective material for the construction of the invention because of its durability, the ease with which the hardened knife-edge may be re-sharpened for many years of use, and its weight for aiding in cutting through lay-down materials.

A provisional patent was granted to the inventor: Provisional Application No. 60/928,504; filing date of May 10, 2007.

### BRIEF SUMMARY OF THE INVENTION

The invention is a simple, durable, safe and effective demolition hand-tool attachment for the construction industry that attaches to various pre-existing, flat-shaped hand-tools such as roofing shovels, potato forks, and floor scrapers. The invention is for making relief cuts in lay down materials such as asphalt shingles, carpet, flooring tile, or linoleum. The relief cuts create smaller, workable portions of the lay-down material for easier removal and clean-up using common techniques. The hand-tool attachment may be made of any material that may provides the strength and cutting ability for attaching to a hand-tool and making relief cuts.

### BRIEF DESCRIPTION OF THE SEVERAL VIEWS OF THE DRAWING

FIG. 1 shows a front-left perspective view of the main body of the invention (1, 2, 3 and 4), and the clamping-plate (5).

FIG. 2 shows a back-right perspective view of the main body of the invention, especially the hollow of the attachment-box (5).

### DETAILED DESCRIPTION OF THE INVENTION

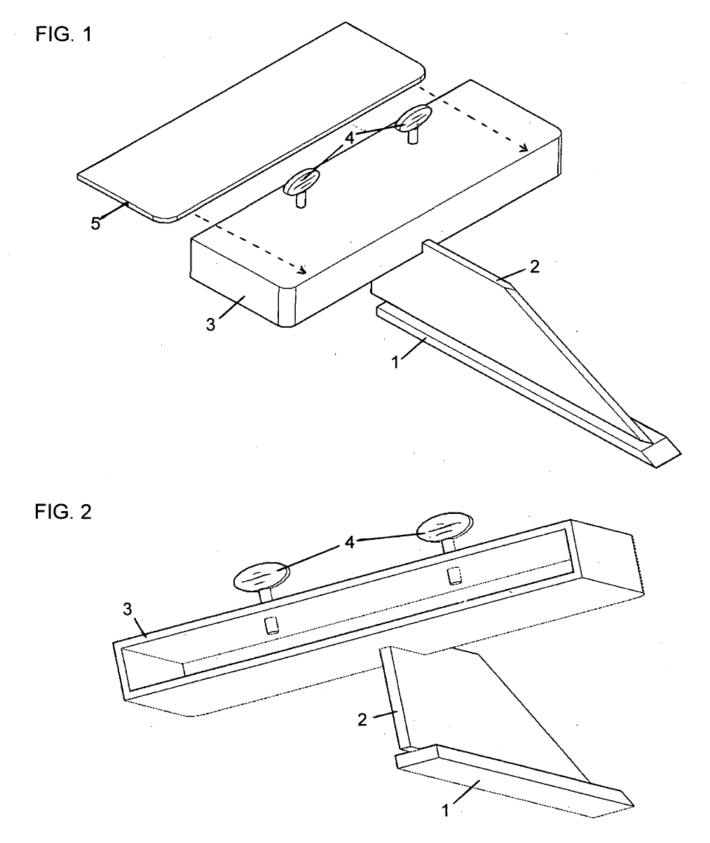

The invention is constructed of high carbon steel or any material that provides the strength and cutting ability for attaching to a hand-tool and making relief cuts. The invention is constructed from high carbon steel, or other appropriate material, which is easily welded or connected for manufacturing the invention. Refer to FIG. 1 and FIG. 2 for the following description.

The invention has a skid plate (1), approximately ¾″×8″, with a tapered leading edge. The tapered leading edge may be shaped to provide easy piercing of a lay-down material, and is used for getting under and lifting up the lay down material into the leading edge of the knife (2).

The invention has a knife (2), approximately ¼″×2″×8″, with a knife-blade angled at approximately 60 degrees. The knife is centrally mounted on top of the skid plate, running parallel and perpendicular to the bottom of the knife, and extends approximately 1″ past the back of the skid plate.

The invention has an attachment-box (3), which is approximately 8½″×2¾″×¾″, and has a narrow, elongated opening that faces away from the leading edge of the skid plate. It is centrally mounted perpendicular to the top of the back side of the knife and overlaps approximately 1¼″ from the back-bottom side of the knife. The attachment-box has two thumb set-screws (4) centrally mounted on the top of the attachment-box, which are used to clamp the clamping-plate (5), which is approximately 7½″×2″×⅛″, to a pre-existing, flat-shaped hand-tool such as a roofing shovel, potato fork, or a floor scraper.

The leading end of the hand-tool to which the invention is attached slides into the attachment-box, resting on the inside bottom thereof. The clamping-plate rests on top of the said hand-tool inside the attachment-box, and the two thumb set-screws are tightened to secure the clamping-plate against the hand-tool.

The leading edge of the entire assembly (the hand-tool with the invention attached thereto), is pushed into the lay-down material. Then, holding the hand-tool in its common fashion, for example, like one would hold and use a roofing shovel, push the entire assembly parallel to the plane of the lay-down material making a relief cut for the desired length. Once the relief cuts are made, the invention is removed from the hand-tool, and the hand-tool, using common techniques, is used for removing the lay-down material.

1. I claim that the invention is a hand-tool that attaches to pre-existing hand-tools for the purpose of making relief cuts in lay-down materials.
